(19) United States
(12) Patent Application Publication
(10) Pub. No.: US 2012/0264233 A1
(43) Pub. Date: Oct. 18, 2012

(54) METHOD OF ANALYSIS WITH IMPROVED MIXING

(75) Inventor: Osten Jansson, Uppsala (SE)

(73) Assignee: GE HEALTHCARE BIO-SCIENCES AB, UPPSALA (SE)

(21) Appl. No.: 13/518,017

(22) PCT Filed: Dec. 21, 2010
(86) PCT No.: PCT/SE10/51446

§ 371 Date: Jun. 21, 2012

(30) Foreign Application Priority Data
Dec. 22, 2009 (SE) 0951004-1

(51) Int. Cl. G01N 21/55

(52) U.S. Cl. 436/501

(57) ABSTRACT

The invention is a method for characterizing an interaction in a liquid environment, between at least one species in solution and a target immobilized on a surface of a flow cell. The method comprises the following steps: (a) activating the surface of the flow cell and immobilizing the target thereon; (b) providing, in a flow of liquid, at least one of the species; (c) passing the flow of liquid comprising at least one of the species through the surface of the flow cell which contains the immobilized target; and (d) detecting a result of an interaction between the at least one species and the target using surface plasmon resonance (SPR) technique. The improvement of the method comprises in at least one of steps (a) or (b), inline mixing at least two liquid solutions to generate a mixed solution before it is passed through the surface of the flow cell.

### TECHNICAL FIELD

The present invention relates to a method and a system for improving the characterization of molecular interactions in a liquid environment. More particularly, the present invention relates to a method and a system for inline mixing of solutions prior to an SPR assay.

### BACKGROUND

Surface Plasmon Resonance (SPR) is a powerful technique for the study of affinity between substrates and targets. Instruments utilizing the principle of SPR measure changes in refractive index of the medium next to a sensor chip, resulting from altered mass concentration at the surface.

SPR is widely used for the detection of the interaction between antibodies and antigens (e.g. protein). Normally, the antibodies directed to the proteins to be analyzed are immobilized to a sensor chip using the amine coupling method. The sensor chip is first activated using an EDC/NHS mixture which is unstable and therefore must be passed over the sensor chip relatively quick after mixing. In instrument lacking advanced liquid handling the mixing of EDC and NHS is currently done by the operator right before the assay. This results in reduced activity due to time.

Another application for SPR is an immunogenecity assay. Drug treatment sometimes initiates antibody response towards the drug which results in a blocked drug effect. It is therefore important to analyse the occurrence of these antibodies in patient serum samples. Prior to analysis the sample then has to be acidified to keep the drug and antibody separated. The sample is then passed over a sensor chip with immobilized drug. However the acidic sample first has to be neutralized to be able to bind to the sensor surface. The sample must pass the sensor surface relatively quick after neutralization since the antibody start to rebind to the drug in solution. The neutralization step is currently routinely done by the operator right before the assay. This results in a lapse of time which leads to reduced accuracy of the assay results.

Yet another application for SPR is concentration analysis of certain samples. Drugs based on antibodies is purified and prepared at very high concentrations (mg/ml range) and these preparations must be diluted to a very high degree before an SPR assay can be performed. A typical application is the analysis of sample fractions from chromatography where pH or ionic strength can be extreme at the same time the concentration can be too high for normal assays. There is thus a general demand to increase the dynamic range for assays on certain samples and in some application also to control the sample matrix in terms of pH and ionic strength.

SPR technology and other bioanalytical instruments use normally microfluidic systems that work in laminar flow condition. In laminar flow mixing is generally a problem since it requires complex flow channel features or active mixing elements. There is therefore a need for a quick and easy-to-perform mixing method which also is well suited for flow cell applications.

### BRIEF DESCRIPTION OF THE PRESENT INVENTION

The present invention relates to systems and methods for improved mixing for an SPR assay. Thus, in a first aspect, the invention is a method for characterizing an interaction in a liquid environment, between at least one species in solution and a target immobilized on a surface of a flow cell. The method comprises the following steps: (a) activating the surface of the flow cell and immobilizing the target thereon; (b) providing, in a flow of liquid, at least one of the species; (c) passing the flow of liquid comprising at least one of the species through the surface of the flow cell which contains the immobilized target; and (d) detecting a result of an interaction between the at least one species and the target using surface plasmon resonance (SPR) technique. The improvement of the method comprises in at least one of steps (a) or (b), inline mixing at least two liquid solutions to generate a mixed solution before it is passed through the surface of the flow cell.

In an embodiment, the inline mixing comprises the following steps: (1) placing a multi-chambered flow cell in an integrated fluidic cartridge (IFC); (2) connecting a multiplex needle and tube block with the integrated fluidic cartridge, wherein a conduit is formed among each of the needles and connected tube, a channel of the IFC and a flow cell chamber; (3) aspirating into the needle a first liquid solution using a pumping means; (4) without introducing an air bubble, aspirating a second liquid solution; and (5) optionally repeat steps (3) and (4); whereas mixing of the first and second liquid solution occurs in said conduit, before the mixed solution reaches the surface of the flow cell. Preferably, the steps are controlled by a computer program.

In a second aspect, the invention provides a method for the analysis of a highly concentrated sample species, comprising subjecting the sample to an SPR assay for characterizing an interaction between the species and a target immobilized on a surface of a flow cell. The method comprises the steps of: (a) activating the surface of the flow cell and immobilizing the target thereon; (b) providing, in a flow of liquid, the species of a suitable concentration; (c) passing the flow of liquid comprising the species through the surface of the flow cell which contains the immobilized target; and (d) detecting a result of an interaction between the species and the target using surface plasmon resonance (SPR) technique. The improvement of the method comprises inline mixing, under the control of a computer, the highly concentrated sample species with a buffer to generate a mixed solution for step (b). The inline mixing comprises the following steps: (1) placing a multi-chambered flow cell in an integrated fluidic cartridge (IFC); (2) connecting a multiplex needle and tube block with the integrated fluidic cartridge, wherein needles in the multiplex needle and tube block are spaced such that each needle could reach a separate reagent well in a standard multiwell plate such as a well in a 96-well plate, further wherein a conduit is formed among each of the needles and connected tube, a channel of said IFC and a flow cell chamber; (3) aspirating into the needle a buffer solution using a pumping means; (4) without introducing an air bubble, aspirating a desired amount of the highly concentrated sample; and (5) without introducing an air bubble, aspirating a second volume of the buffer solution. Dilution of the highly concentrated sample occurs in the conduit, before the sample reaches the surface of the flow cell.

### BRIEF DESCRIPTION OF THE DRAWINGS

FIG. 1 is a schematic of the injection and flow systems for inline mixing according to one embodiment of the invention.

FIG. 2 illustrates a variation of the injection and flow systems for the method according to one embodiment of the invention. An auto-sampler table is shown as part of the flow system.

FIG. 3 is a schematic sketch of the short injection principle. In practice, the two reagents are intermixed before arriving at the sensor chip.

FIG. 4 shows the sensorgrams for inline mixing of running buffer (HBS EP+) and water, using 2 μl segments each at (A) 10 μl/min and (B) 60 μl/min, respectively.

FIG. 5 shows deviation from average mix level, for certain segment volumes and flow rates, respectively.

FIG. 6 shows mixing capacity using inline mixing at different flow rates and segment volumes.

FIG. 7 shows results of inline mixing of EDC and NHS, for immobilising human serum albumin using amine coupling method. FIG. 7A: results obtained in four of the eight parallel flow cells including inline mix of EDC and NHS. FIG. 7B: results obtained in the other four parallel flow cells which involved manual mixing of EDC and NHS.

FIG. 8 is a comparison, between manual and inline mixing of EDC and NHS as described in described in FIG. 7, for the immobilization levels of human serum albumin.

FIG. 9 illustrates that short injection responses correlate well with the sample volume, according to an example.

FIG. 10 is an overlay plot of two injections with a biatest solution showing the bulk response and two injections with Xolair antibody on protein A immobilized sensor chip, according to an example.

FIG. 11 show average response (A) and standard deviation (B) from duplicates of Xolair antibody binding. Shown are binding levels of Xolair antibody for short injections at different sample concentrations from 1 to 1000 μg/ml, mixing flow rates 10 to 60 μl/min, contact time flow from 25 to 100 μl/min and injection volumes from 1-4 μl. 1000 μg/ml.

FIG. 12 shows binding levels of different concentrations of Xolair antibody by short injections although the precision is lower at the lowest concentration.

FIG. 13 plots the precision of response after short inject of Xolair antibody at different concentrations and sample volumes. Each staple is calculated from 2 measurements.

FIG. 14 is a plot showing that ultra short injections provide a linear response from 0.25 μl sample injection, providing at least a 40 fold dilution (FIG. 14). The dotted lines represent the limits for the confidence interval of 99%.

FIGS. 15 A and B shows results of a test for pump fluctuations. A flow rate variation of ±4.5 μl/min was identified with the pumps used, with a frequency of ca 1 μl between bottom to top flow rate for both 10 and 20 μl/min.

FIG. 16 shows a schematic sketch of the combined inline mixing principle. (A) Aspiration of segments, (B) Dispensing sample into a mixing well, (C) Aspiration of sample from mixing well and injection of mixed sample.

FIG. 17 shows the sensorgrams for combined inline mixing of buffer and 15% sugar, respectively.

### DEFINITIONS

For the purpose of this application, a “species” is any entity such as a molecule, a compound, substance, antibody, antigen, cell, cell fragment, or any other moiety that can be provided in a liquid environment. In order to be detectable, it should preferably be capable of some sort of interaction with another species (or target), a result of the interaction being detectable by some means. However, of course, in certain instances an analyte maybe does not to interact with another species of interest, and thus no explicit result of interaction can be measured, but this lack of result is also detectable, and therefore this kind of non-interacting species is also included in the definition of species.

### DETAILED DESCRIPTION OF THE INVENTION

The method according to the invention can be used with a variety of detection systems, based on use of a label or may, preferably, be label-free. Preferably, detection is performed with a sensor, such as a biosensor, in which case the solid support surface is a sensing surface of the (bio)sensor.

A biosensor is broadly defined as a device that uses a component for molecular recognition (for example a layer with immobilised antibodies) in either direct conjunction with a solid state physicochemical transducer, or with a mobile carrier bead/particle being in conjunction with the transducer. While such sensors are typically based on label-free techniques detecting a change in mass, refractive index or thickness for the immobilized layer, there are also biosensors relying on some kind of labelling. Typical sensors for the purposes of the present invention include, but are not limited to, mass detection methods, such as optical methods and piezoelectric or acoustic wave methods, including e.g. surface acoustic wave (SAW) and quartz crystal microbalance (QCM) methods. Representative optical detection methods include those that detect mass surface concentration, such as reflection-optical methods, including both external and internal reflection methods, which may be angle, wavelength, polarization, or phase resolved, for example evanescent wave ellipsometry and evanescent wave spectroscopy (EWS, or Internal Reflection Spectroscopy), both of which may include evanescent field enhancement via surface plasmon resonance (SPR), Brewster angle refractometry, critical angle refractometry, frustrated total reflection (FTR), scattered total internal reflection (STIR) (which may include scatter enhancing labels), optical wave guide sensors, external reflection imaging, evanescent wave-based imaging such as critical angle resolved imaging, Brewster angle resolved imaging, SPR-angle resolved imaging, and the like. Further, photometric and imaging/microscopy methods, “per se” or combined with reflection methods, based on for example surface enhanced Raman spectroscopy (SERS), surface enhanced resonance Raman spectroscopy (SERRS), evanescent wave fluorescence (TIRF) and phosphorescence may be mentioned, as well as waveguide interferometers, waveguide leaking mode spectroscopy, reflective interference spectroscopy (RIfS), transmission interferometry, holographic spectroscopy, and atomic force microscopy (AFR).

Biosensor systems based on SPR and other detection techniques are commercially available today. Exemplary such SPR-biosensors include the above-mentioned BIACORE® instruments. A detailed discussion of the technical aspects of the BIACORE® instruments and the phenomenon of SPR may be found in U.S. Pat. No. 5,313,264. More detailed information on matrix coatings for biosensor sensing surfaces is given in, for example, U.S. Pat. Nos. 5,242,828 and 5,436,161. In addition, a detailed discussion of the technical aspects of the biosensor chips used in connection with the BIACORE® instrument may be found in U.S. Pat. No. 5,492,840. The full disclosures of the above-mentioned U.S. patents are incorporated by reference herein.

The invention is illustrated in the examples mainly with the use of SPR, which should not be taken to be limiting on the scope of the invention.

First a brief description of the SPR technique as used in the Biacore® systems will be given.

In SPR, changes in refractive index of the medium next to a sensor chip, resulting from altered mass concentration at the surface, are measured. The signal is measured in response units, RU, 1 RU corresponding to an approximate surface concentration of 1 pg/mm², and graphically presented as a function of time in a sensorgram. In the terminology for the purpose of this application, the molecule attached to a surface is referred to as the target, whereas the compound to be analyzed is the molecule (species) in solution. The solution containing the compound is injected over a surface, the sensor chip, typically coated with a carboxymethyl-dextran matrix, and transported by a continuous flow. The process is driven by a system of automated pumps and sample robotics.

Target is covalently bound to the sensor chip matrix in a process called immobilization. The most commonly used immobilization technique is amine coupling, in which reactive esters are introduced into the surface matrix by modification of the carboxymethyl groups. These esters then react spontaneously with amines and other nucleophilic groups on the target to form covalent links. The covalent coupling withstands conditions that break the bonds between target and compound, a process called regeneration. The same surface can therefore be used several times.

During injection, compound molecules are continuously transported to the surface, and allowed to associate with target molecules. When the injection stops, the buffer flow washes off dissociated compounds. The association phase is described by (for 1:1 binding)

dR/dt=kₐC(Rₘₐₓ−R)−k_{d}R (1)

At equilibrium the response is obtained as

R_{eq}=kₐCRₘₐₓ/(kₐC+k_{d}) (2)

and during dissociation as

dR/dt=−k_{d}R₀ (3)

where R signifies the response at any time t, R_{eq} the response at equilibrium, R₀ the response at the end of an injection, and Rₘₐₓ the maximum binding capacity of the surface in RU. C is the molar concentration of the compound of interest.

Thus a first challenge in an SPR assay is related to the lack of stability of the EDC/NHS mixture during surface preparation for amine coupling. The EDC/NHS mixture is unstable and therefore must be passed over the sensor chip relatively quickly after mixing. This is solved by using inline mixing as described here, using a pulse train without air bubble in between. This makes it possible to automate the immobilization of a target protein or antibody in a very simple manner.

One aspect of the present invention is thus of a method and a system which can be used to provide inline mixing of at least two solutions for a SPR assay. The principles and operation of the system and method according to the present invention may be better understood with reference to the drawings and accompanying descriptions.

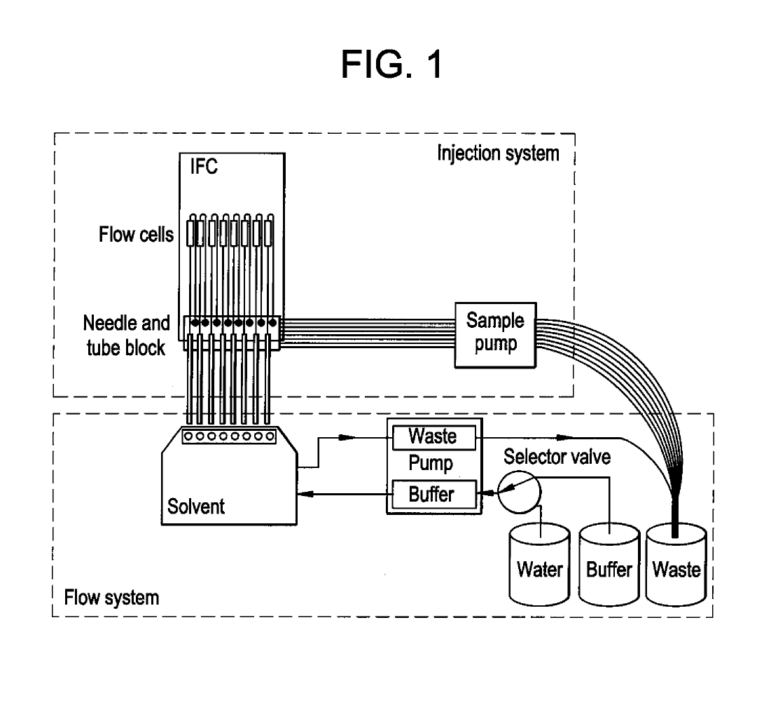

Referring now to the drawings, FIG. 1 illustrates schematically part of a system for performing a method using the principle of inline mixing according to the invention. It comprises an injection system, which for the purpose of this invention comprises a multi-chambered flow cell (i.e., sensors), an integrated fluidic cartridge (IFC), a multiplex needle and tube block, as well as tubing and pumps in which the liquids to be characterized flow. It further comprises a flow system including a reagent block (i.e. auto-sampler table). Other parts of the sensor device for detecting a result of an interaction between at least a first compound and another species (target) are not shown.

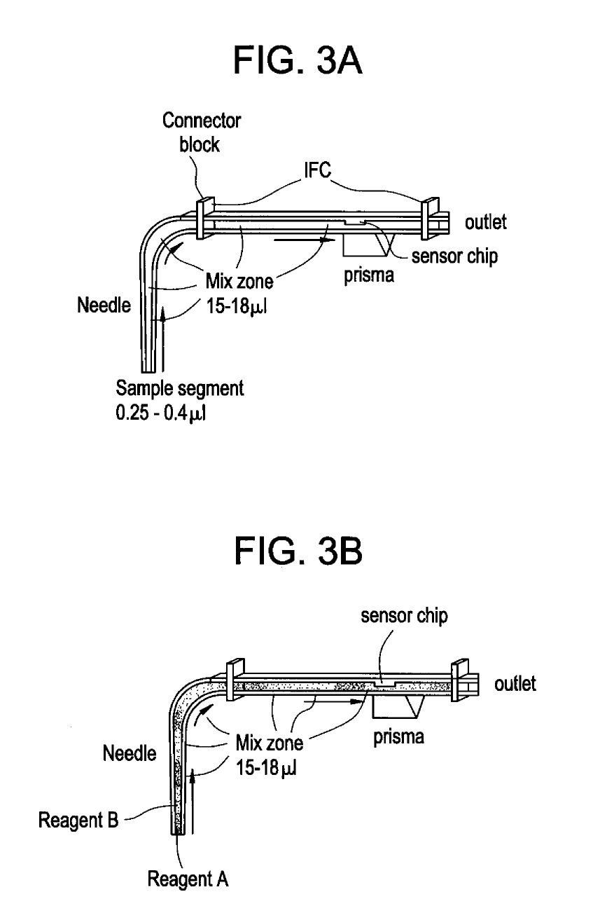

Inline mixing is achieved through the following steps: (1) placing a flow cell such as a multi-chambered flow cell in an integrated fluidic cartridge (IFC); (2) connecting a multiplex needle and tube block with the IFC to form a conduit among each of the needles and contacted tube, a channel of the IFC and a flow cell chamber; (3) aspirating into the needle a first liquid solution from the reagent container using a pumping means; (4) without introducing an air bubble, aspirating a second liquid solution from a different reagent container; (5) repeat steps (3) and (4); whereas mixing of the first and second liquid solution occurs in the conduit, before the solution reaches the surface of the flow cell (FIG. 3). Preferably, the needles in the multiplex needle and tube block are spaced such that each needle could reach a separate reagent well in a standard multiwell plate such as a well in a 96-well plate. Optionally, the multiplex needle and tube block contains 8 or 12 needles which are spaced such that each needle could reach a separate well of a row of wells in a 96-well plate. The pumps and/or valves are used for passing the flow through the conduit, and for aspirating the liquid from each of the reagent container (well), under the control of the control unit.

Thus, the system is run under the control of software in the form of a computer program product directly loadable into the internal memory of a processing means coupled to the system. The program comprises the software code means for performing the steps of the method according to the invention.

The software can also be in the form of a computer program product stored on a computer usable medium, comprising a readable program for causing a processing means in the apparatus to control an execution of the steps of the method according to the invention.

An example of the system provides that the multiplex needle and tube block moves vertically, while the reagent block of the flow system carrying the reagent plate moves horizontally.

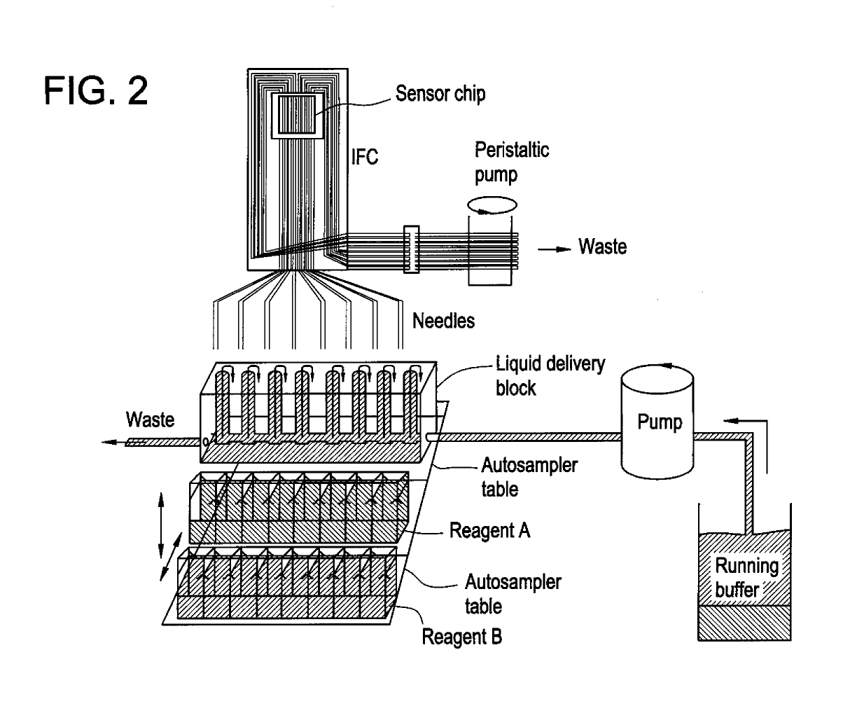

A slight variation of the system is shown in FIG. 2.

Preferably, the needles are made of stainless steel. Also preferably, each of the needles has a diameter of 0.4 mm. Exemplary pumping means include a peristaltic pump, a syringe pump or any accurate pump.

The inline mixing method according to the present invention can be achieved over a wide range of volumes and flow rates. Effective mixing is achieved while between from about 0.1 to about 10 μl of a solution is aspirated into the needle during each step. Preferably, from about 0.25 to about 4 μl of a solution is aspirated into the needle during each step. Still more preferably, from about 0.5 to about 4 μl of a solution is aspirated into the needle during each step. The flow rate for the sample liquid through the flow cell may be from about 10 to about 100, preferably from about 10 to about 20, and more preferably from about 10 to about 30 μl/min. Effective mixing is achieved while the two or more solutions travel in the conduit prior to reaching the flow cell. By controlling the segment size and the flow rate during the transport through the flow line the mixing is achieved.

As can be seen in FIG. 2, there is provided an auto-sampler table which can hold two or more reagent plates (racks) containing different solutions such as sample and buffer, respectively. The needles for aspirating the solution as well as the reagent plates are controlled by the computer program so that the needles can aspirate the required solution sequentially and repeatedly as needed.

The needle and tube block is coupled to an Integrated Fluidic Cartridge (IFC), a device enabling controlled liquid delivery to one or more flow cells. Each flow cell has a sensor surface onto which one or more suitable target(s) are immobilized. The flow is controlled by accurate pumps, whereby the actual flow rates can be monotonically controlled to provide the desired flow rates, ranging from zero flow to the maximum flow rates required, or combinations thereof (FIG. 1).

The first step in the procedure is to aspirate a small volume of a first solution into the needle, i.e., to immerse the needle into the first tube, and to aspirate the appropriate volume into the needle. Then, the needle is moved to the second tube and a suitable volume of second solution is aspirated. The actual volume may depend on the application and the kind of sample, and can vary within wide limits, say between 0.1 μl and 10 μl.

The aspiration of sample will lead to mixing of the sample and buffer by the parabolic flow profile in the laminar flow and dispersion in the tubing.

Thus in one embodiment, the system is suitably used to inline mix EDC (1-ethyl-3-(3-dimethylaminopropyl)carbodiimide HCl) and NHS (N-hydroxysuccinimide) for sensor surface preparation. The mixing is completed in the tubing before the liquid arrives at the sensor surface. This process as shown in the examples below takes only seconds (less than from about 1-2 minutes), avoids the problem of the instability of the mixture. Provided therefore is an automated process for surface preparation for amine coupling.

In another embodiment, the system and method is suitable in general for inline mixing of any two or more liquid solutions. Preferably, the method is particularly useful where at least one of the solutions contains at least one chemically unstable component. One application of the method thus relates to a method of determining the total concentration of an analyte in fluid samples wherein the analyte at least partially may be present as a complex with an analyte-binding species, typically as an immune complex.

In this case, the sample is first subjected to conditions that dissociate any complexes present in the sample (by reducing the affinity for the binding between the analyte and analyte-binding species), typically by adding a dissociating agent to the sample, so that all analyte will be in free form. The sample is then subjected to conditions that restore the binding affinity, and the concentration of free analyte in the sample is determined substantially immediately before any substantial re-complexing of the analyte has taken place, preferably via its binding to an anlyte-specific ligand.

The sample may be any sample that contains or is suspected of containing an analyte of interest which at least partially is in complex form. Typically, however, the sample is a serum or plasma sample from a mammal, preferably human, and the complex is an immune complex (i.e. an antigen-antibody complex).

The analyte may, for example, be an antibody elicited in response to a drug, e.g. a protein drug, such as a therapeutic antibody.

The term “antibody” as used herein refers to an immunoglobulin which may be natural or partly or wholly synthetically produced and also includes active fragments, including Fab antigen-binding fragments, univalent fragments and bivalent fragments. The term also covers any protein having a binding domain which is homologous to an immunoglobulin binding domain. Such proteins can be derived from natural sources, or partly or wholly synthetically produced. Exemplary antibodies are the immunoglobulin isotypes and the Fab, Fab′, F(ab′)₂, scFv, Fv, dAb, and Fd fragments.

Examples of other analyte-complexes (usually protein-complexes) that may need to be dissociated to permit measuring the analyte include PSA (prostate specific antigen), PSA being a protein which to a great extent is in complex-form and for which it is of interest to be able to determine the proportion of complex. In blood, about 70-90% of the PSA is in complex with alpha-1-antichymotrypsin, but PSA is also known to form complexes with e.g. protein C inhibitor, alpha-1-antitrypsin and alpha-2-macroglobulin. The ratio of free to total PCA would be a useful marker for prostate cancer, but there is presently no antibody that could be used to detect complexes with alpha-2-macroglobulin, PSA being completely enclosed by alpha-2-macroglobulin in the complex (Balk et al. (2003) J. Clin. Oncology 21, 383-391). This would presumably be the case also for other protein complexes.

A variety of reagents and conditions may be used to accomplish dissociation of analyte-containing complexes. Immune complexes may, for example, be dissociated by acidic or basic agents which subject the complex to low or high pH conditions, respectively. Restoration of analyte binding activity may then be effected by bringing the acidified or alkalized sample to a substantially neutral pH. Other reagents and conditions include, for example, chaotropic salts, high or low ionic strength, organic salts.

A basic feature of the embodiment of the invention is that it enables the measurement of analyte concentration substantially immediately after the sample has been treated to restore the binding capability (to ligand as well as to complexing species), such as by neutralization of an acidified or alkalized sample. By “substantially immediately” is meant that re-complexing of the analyte (depending on inter alia the analyte, the complexing species and the assay device used) should not have had time to take place to any appreciable extent. On the other hand, sufficient time must be provided for the treatment of the sample to restore the analyte binding capability, such as neutralization, to be substantially completed, before the measurement takes place (which depends on inter alia the reagents and assay device used). It is, however, within the competence of a person skilled in the art to find an optimum time for the measurement for each particular assay system. Preferably, no more than about 5% of the analyte should be in complex form, more preferably less than about 1%, when the analyte concentration is measured.

By also determining the analyte concentration without complex dissociation, the proportion of free analyte to complex-bound analyte in the sample may also be determined.

Preferably, a heterogeneous assay system comprising a sensor surface with an immobilized analyte-specific ligand is used for measuring the analyte concentration by detecting directly or indirectly the amount of binding to the surface, either of the analyte (direct assay, including sandwich assay; or displacement assay) or of a detectable analyte analogue (competition assay).

In case the analyte is an antibody, the immobilized ligand may be an antigen. When, on the other hand, the analyte is e.g. PSA, the solid support surface may have e.g. anti-PSA and preferably also alpha-1-antichymotrypsin, protein C inhibitor, alpha-1-antitrypsin and alpha-2-macroglobulin immobilized thereto.

A heterogeneous assay based on the inventive concept could also be used in so-called ligand fishing. Assume, for example, that it is of interest to know which species, such as proteins, that bind in vivo to a specific protein. The specific protein may then be immobilized to a sensor surface, and the sample (e.g. a cell extract or plasma) containing the specific protein is contacted with the surface immediately after the surface has been treated to first dissociate complexes and then restore the binding affinity of the interacting species. (Without such treatment of the sample, if all or substantially all binding proteins would already be bound to the specific protein in the sample, no or very little binding of binding proteins to the surface would be obtained). The protein or proteins that have bound to the specific protein immobilized on the surface may then be identified, such as by mass spectrometry.

As mentioned above, it is important that the sample is contacted with the solid support surface, or detection area, substantially immediately after the sample has been treated to restore the binding capability of the analyte. The distance between the detection area and the needle, and the fluid flow rates should be selected such that when the mixed fluids reach the solid support area, the binding capability of the analyte has substantially been restored, e.g. an acidified sample is substantially neutralized by an alkaline fluid, but re-complexing of the analyte has substantially not taken place.

In another embodiment, the system and method for inline mixing is useful for concentration analysis of a highly concentrated sample. Specifically, a high concentration sample is inline mixed with a buffer at desired ratios, and the mixture is subject to a SPR type assay. The method is particularly suitable for the analysis of samples containing high salt or low pH. It was found, as expected, that response level was mainly controlled by sample volume and contact time. Sample aspiration and mix flow rates were not as critical. Sample volumes tested showed a linear relationship with SPR response and with a relative precision of 5-10% CV. It was possible to control the dilution factor between 5-100 fold, such as between 5-40 fold. The precision was limited by the peristaltic pump performance. By using a more accurate pump such as a piston operated pump the precision can be improved by at least a factor of 10. Short injection can thus be used for simultaneously automated dilution and concentration analysis of a sample in a Biacore or a related SPR system.

It is noted that under this embodiment, the sample is taken as only one small segment and it is automatically diluted by the running buffer. It has two functions; 1) the sample concentration is lowered, and 2) the sample matrix (the solution) can if needed be changed to a solution suitable for binding analyses. A typical application is analysis of sample fractions from chromatography where pH or ionic strength can be extreme at the same time the concentration can be too high for normal assays.

In SPR assays using the Biacore system, the binding rate is typically 5-10 (RU/s)/(μg/ml), the binding capacity is typically 1000-5000 RU. This means that for a sample at 1 mg/ml concentration the assay is fully saturated in 0.1-1 s of sample exposure. In Biacore systems the flow rate is in the 10-100 μl/min range so the actual volume that is transported over the sensor surface during 1 second is in the 1 μl range. In the prior art system, the contact time for sample need to be decreased down to tenths of milliseconds, and requires handling of submicroliter volumes which is impossible with precision in most fluidic systems.

The present invention solves the problem by using the needles which can handle very small volumes, dilute the sample by in-line mixing and expose the sensor surface during a short period of time. This is achieved with a very simple yet fully automated apparatus. It requires only a flow line, a detection flow cell and a pump. The flow line need an inner volume that is considerably larger than the sample volume. In the case of submicroliter sample volumes the preferred volume of the inner volume is greater than 1 μl.

The sample is aspirated as a segment contacting running buffer both in front and back. By the parabolic flow profile in the laminar flow and diffusion the sample segment is diluted by the running buffer. By controlling the segment size and the flow rate during the transport through the flow line the dilution is controlled and by controlling the flow rate during sample exposure to the sensor surface the contact time is controlled thereby the binding level.

Although this is described using the Biacore system, this method is equally applicable to other instruments, with the advantage of the advanced microfluidic cartridge (IFC).

### EXAMPLES

The present examples are presented herein for illustrative purpose only, and should not be constructed to limit the invention as defined by the appended claims.

### Example 1

### Proof of Concept—Mixing of Water and Running Buffer

Inline mixing of water (reagent B) and running buffer (reagent A; 0.01 mM HEPES, 0.15 M NaCl, 3 mM EDTA and 0.05% v/v Surfactant P20, pH 7.4) in a Biacore Q100 instrument (GE Healthcare, Uppsala, Sweden) was performed as proof of principle.

Below is the simple MDL code for creating mixing in Biacore Q100 and similar instruments. This applied to the other Examples as well.

| | |
|---|---|
| FLOW | 0 |
| WAIT | % pumpwait |
| POS | % pos_reagent1 |
| FLOW | % FLOW |
| WAIT | % segtime |
| FLOW | 0 |
| WAIT | % pumpwait |
| POS | % pos_reagent2 |
| FLOW | % FLOW |
| WAIT | % segtime |

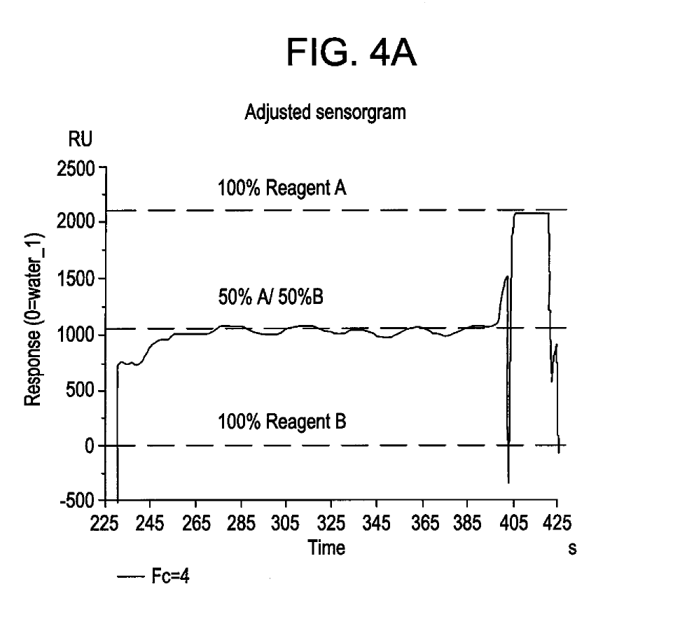

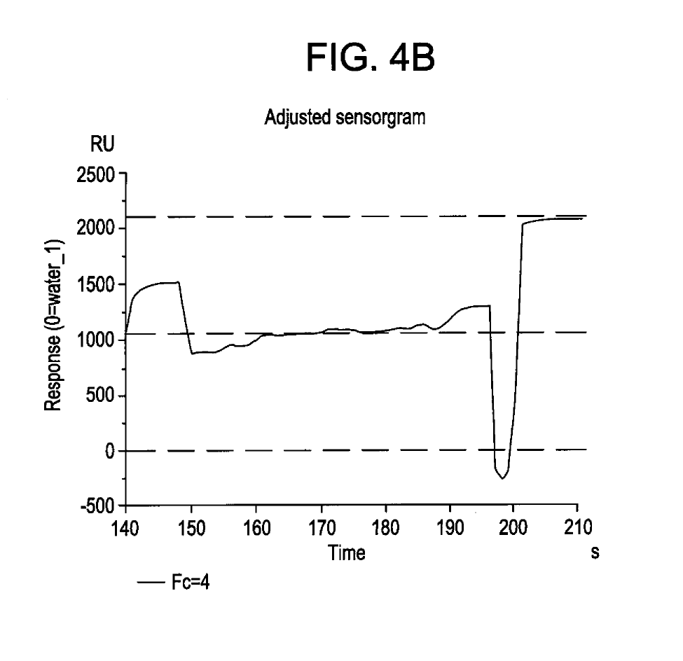

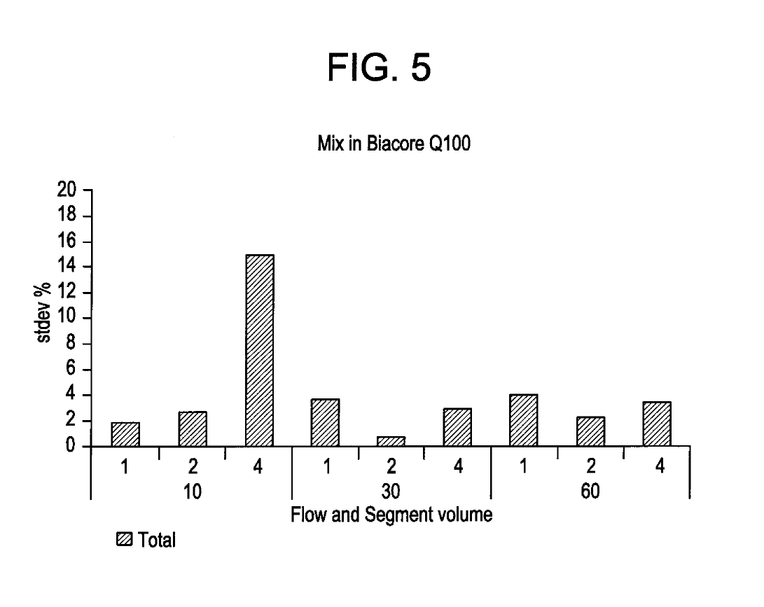

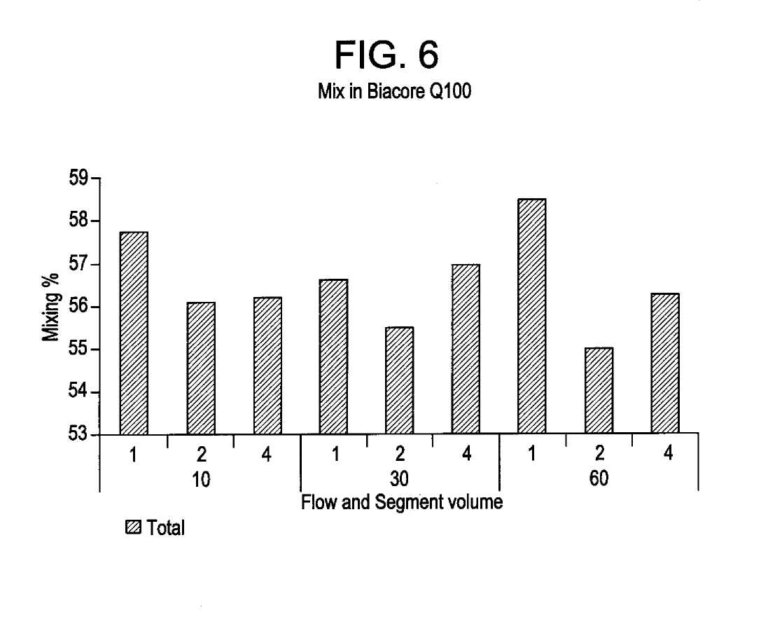

The mixing zone is 15-18 μl which is the dead volume from needle tip to sensor surface. The example has seven segments of reagent A and B respectively. The sample pump stops when auto sampler moves from A to B and this stop time is about 2-3 seconds. The mix time at 10 μL/min is then 1.5 to 1.8 minutes plus ca 24-27 seconds for the 7.5 to 9 pump stops and 0.25-0.3 minutes plus ca 24-27 seconds at 60 μl/minute. A faster auto sampler could of course speed this up further. FIG. 4 shows the results. Running buffer (HBS EP+), Reagent A and water, Reagent B, were mixed using 2 μl segments each at (A) 10 μl/min and (B) 60 μl/min, respectively. Mixing at different flow rates and segment sizes showed that the precision was good at flow rates from 10 to 60 μl/min with up to 2 μl segments. As expected larger segments at low flow rate did not mix well (See 4 μl segments at 10 μl/min), FIG. 5. Ideally, the mixing capacity was expected to be 50%. The result obtained was very close to 50%, FIG. 6.

### Example 2

### Immobilization of Human Serum Albumin

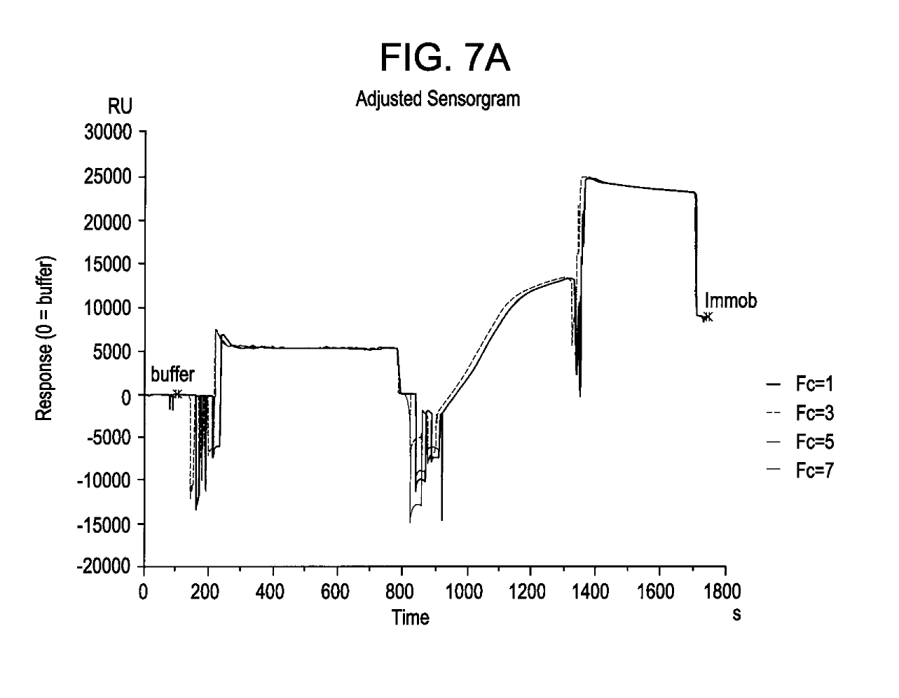

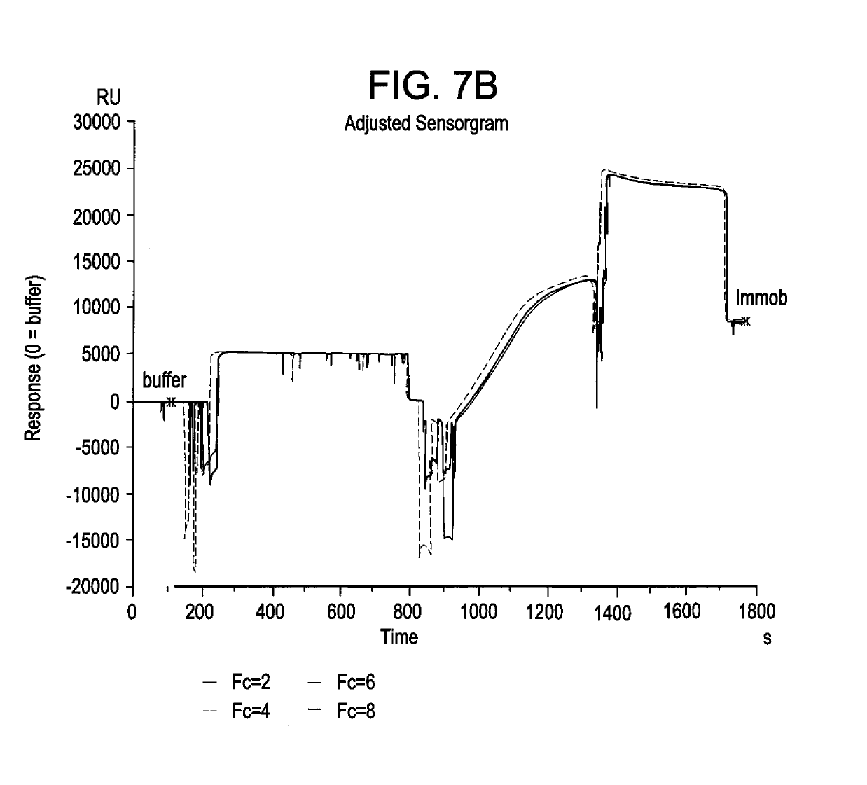

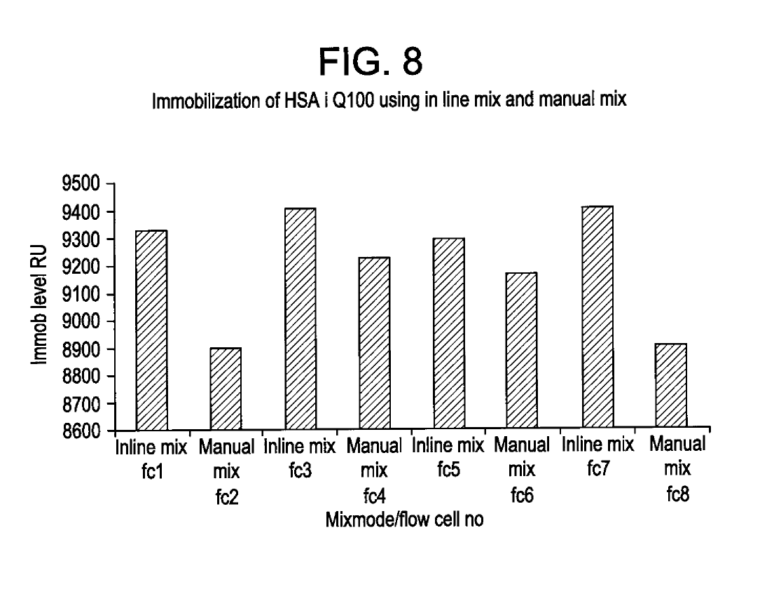

Human serum albumin was immobilized in four of the eight parallel flow cells using amine coupling method involving inline mix of EDC and NHS, see FIG. 7A. Manual mixing of EDC and NHS was performed in the remaining four flow cells in the same run, see FIG. 7B. All steps except mixing were identical for immobilization of HSA. For inline mixing, segments (21) with EDC and NHS, 2 μl each at 10 μl/min, with a contact time of 9 min. HSA concentration was 17 μg/ml in 10 mM acetate buffer pH 5.0. Running buffer was HBS EP+. The immobilized level was almost identical between manual and inline mixed reagents with a little favour of inline mixing and with very little variation between flow cells, see FIG. 8. (The sensorgrams show a record of the SPR response as a function of time. The illustration shows a typical sensorgram from immobilization of HSA using the amine coupling method. Continuous flow is maintained over the sensor surface throughout the experiment by switching between buffer, sample and reagent solutions as shown at the top of the figure. The transient changes in response at the beginning and end of each injection are caused by small air bubbles introduced to separate the injected solution from running buffer. The immobilized level is the difference between the start point of the sensorgram and the end of the same.)

### Example 3

### Concentration Analysis

### 1. Materials and Methods

### 1.1. Materials:

| | | |
|---|---|---|
| Instrument | Biacore Q100 | |
| Samples | 1. Biatest solution | Biacore |
| | 2. Xolair antibody 10 mg/ml; Bioreagens | |
| | nr 2327 Mw 149000; according to | |
| | manufacturer it also contains sacarose, | |
| | histidin, histidinhydrochloridemonohytrate, | |
| | polysorbat 20 and water. | |
| Running buffer | HBS EP+ | Biacore |
| Amine coupling | | Biacore |
| kit | | |
| Protein A | 350 μg/ml pH 4.65 051207 LeVi | Biacore |
| Immobilization | 10 mM acetate pH 4.6 | |
| buffer | | |
| Regeneration | Glycine pH 1.7 (Mix 54 ml glycine | |
| buffer | pH 2.0 and 46 ml glycine pH 1.5) | |
| Sensor chip | CM5 | Biacore |

### 1.2. Methods:

### 1.2.1 Immobilization

| | |
|---|---|
| Activation. | 9 minutes using inline mix of EDC/NHS |
| | (The activation steps were identical with |
| | example 2). |
| Immobilization. | 7 minutes with 10 μg Protein |
| | A/ml immobilization buffer. |
| Deactivation | 7 minutes. |

### 1.2.2. Short Injections

A very small sample segment, 0.25-4 μl, was injected without air segment separation from running buffer in the front. The sample was thereby diluted (mixed) in running buffer during the 15-18 μl transportation volume to the flow cell. The sample was thus analyzed without manual dilution. Mix time and contact time over sensor chip was controlled by flow rate settings. A sketch of short injection principle is shown in FIG. 3.

### 2. Results

### 2.1.1. Immobilization

Immobilization of protein A resulted in 4332 RU immobilized protein A.

### 2.1.2. Short Injections

### 2.1.2.1. Different Sample Concentrations

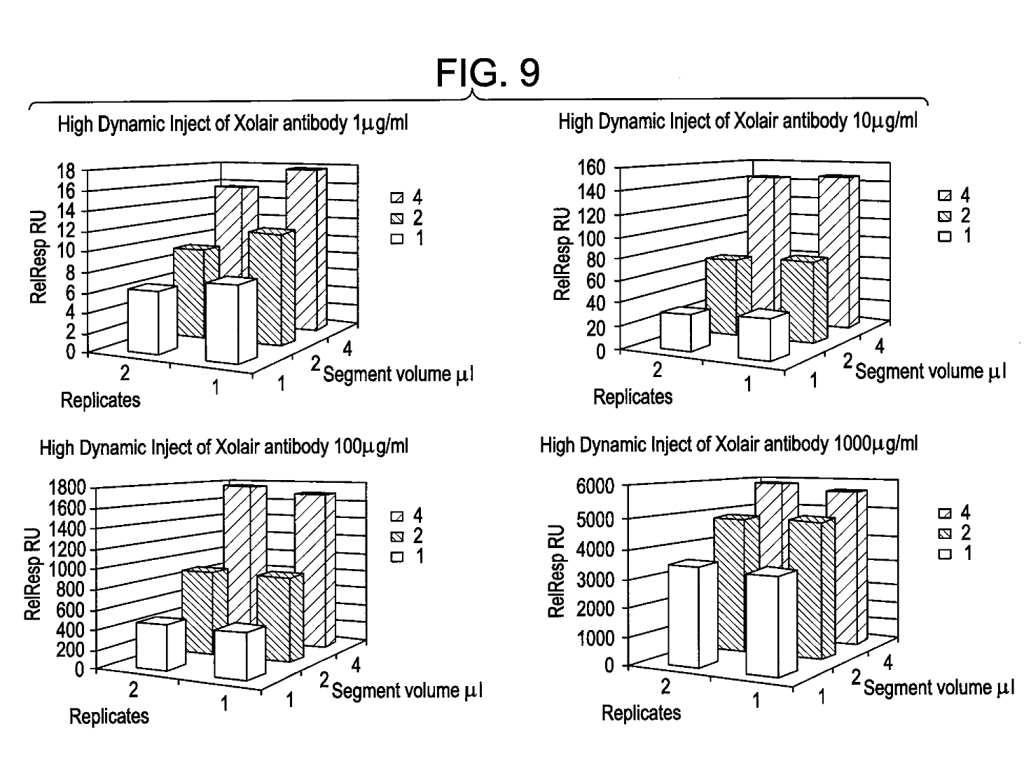

FIG. 9 shows that short injection responses are well correlated with the sample volume. The responses obtained with 1000 μg/ml antibody are closest to Rmax due to the high concentration of the sample and therefore not linear. Two flow cells were run in parallel and the responses were reasonably similar between the flow cells. The contact flow was 100 μl/min. Mix and sample aspiration flow rate were 10 μl/min.

Mix flow between 10 and 60 μl/min does not affect the mixing of the sample without consideration of pump fluctuation at aspiration of the sample (data nit shown).

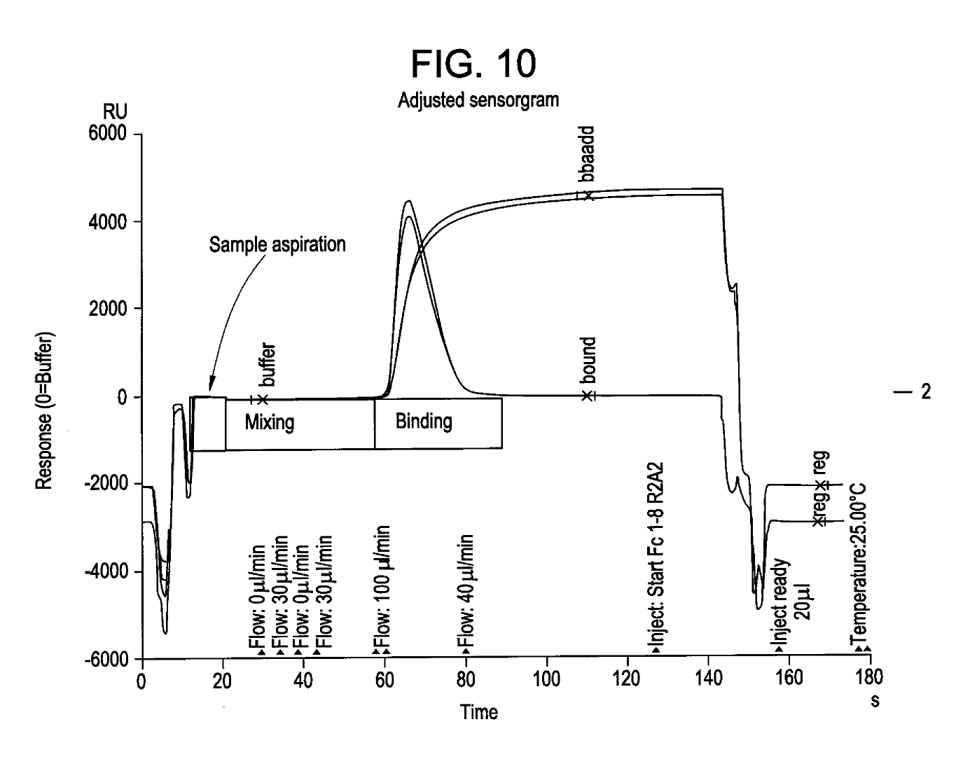

In FIG. 10 short injection is illustrated in an overlay plot from two equal injections with a Biatest solution sample showing the bulk response only and other two equal injections with Xolair antibody showing the binding to the sensor chip. The bulk response of Biatest solution represents the actual contact time of the sample and the concentration profile of the sample during that contact time. It is also shown that the sample is diluted by ca 5 times measured at the peak response of the biatest solution (22500 RU/4300 RU=5.2 times dilution). Sample segment was 2 μl, mixing flow 30 μl/min and contact flow 100 μl/min.

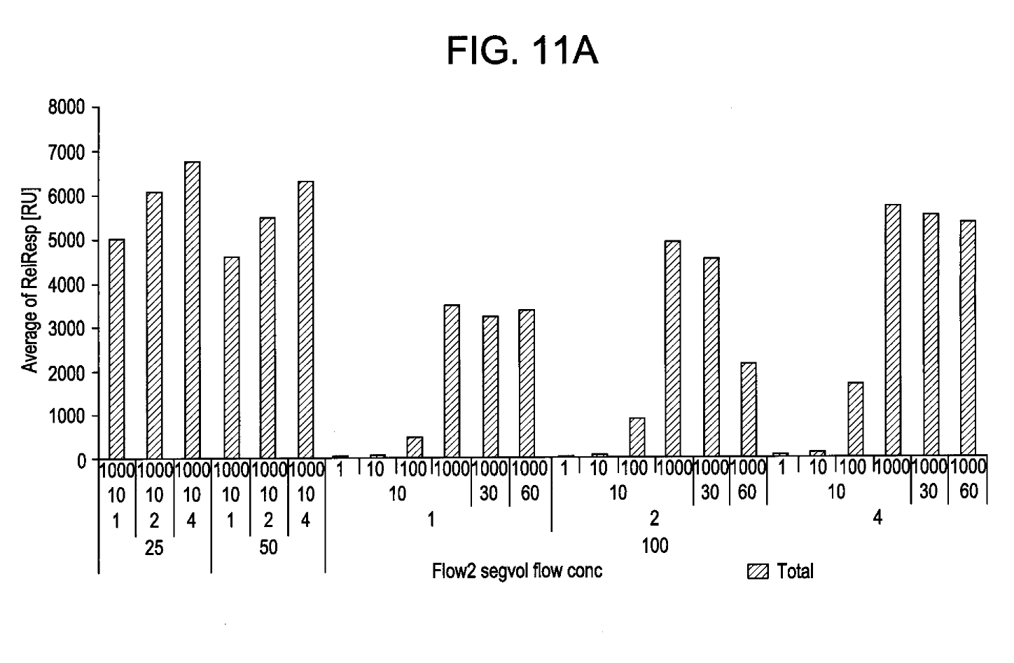

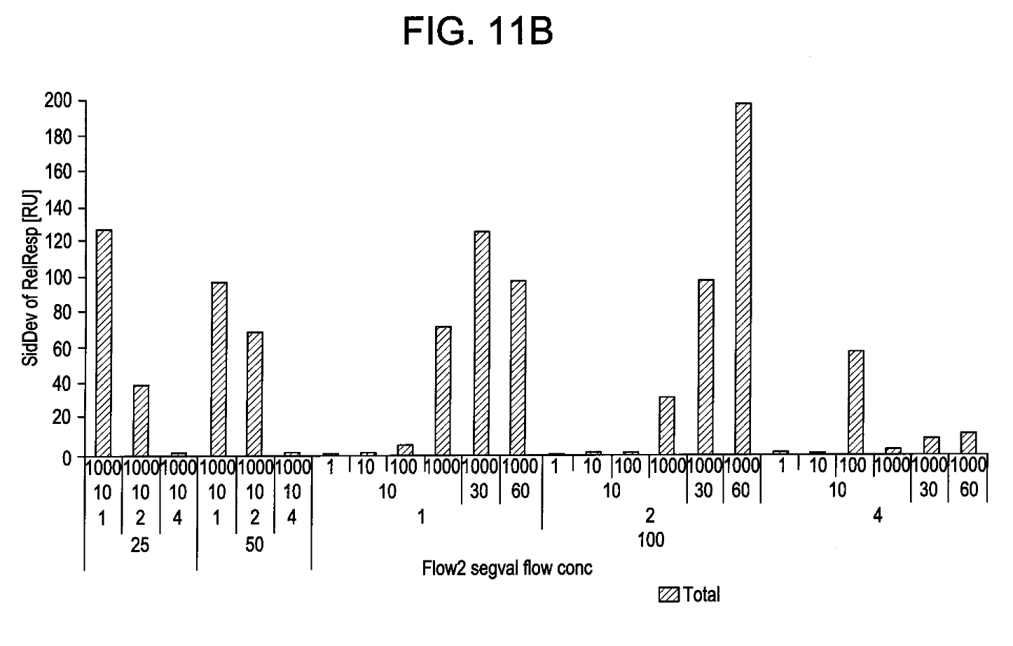

FIG. 11 show average response and standard deviation from duplicates of bound Xolair antibody. Shown are binding levels of Xolair antibody for short injections at different sample concentrations from 1 to 1000 μg/ml, mixing flow rates 10 to 60 μl/min, contact time flow from 25 to 100 μl/min and injection volumes from 1-4 μl. 1000 μg/ml.

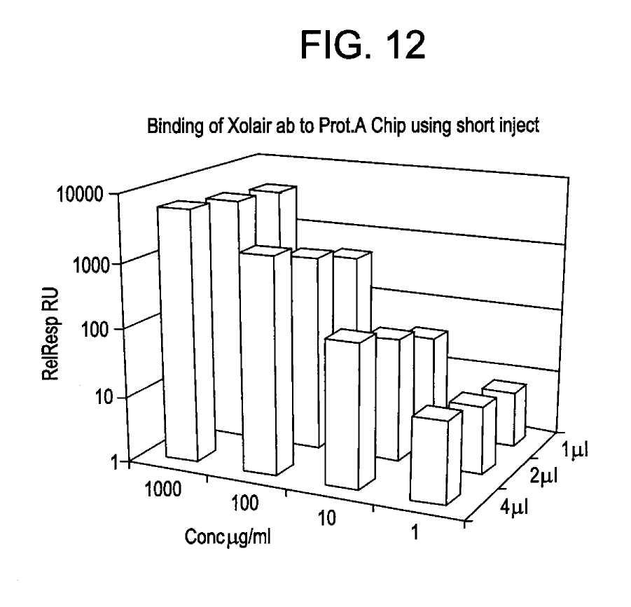

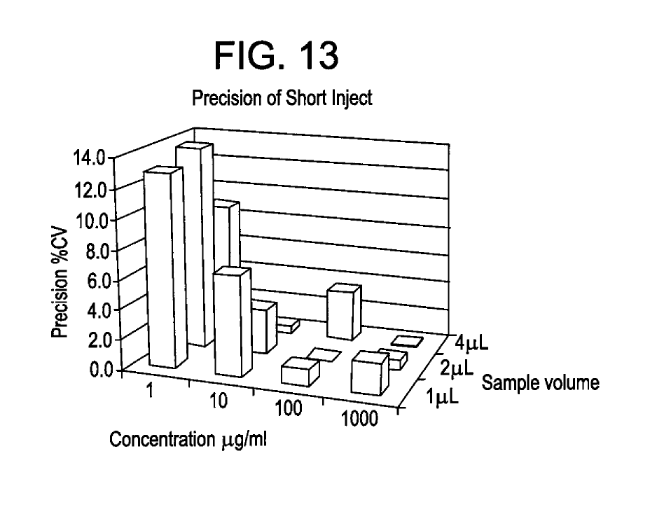

Concentrations between 1000 and 1 μg/ml, which is 4 orders of magnitude, can be determined by short injections although the precision is lower at the lowest concentration (FIG. 12). Binding of Xolair antibody diluted in running buffer using short inject. Each staple is an average of two measurements. The precision of response after short inject of Xolair antibody at different concentrations and sample volumes are shown in FIG. 13. Each staple is calculated from 2 measurements.

### 2.1.2.2. Factorial Experiment

The goal was to find the parameters that impact most on bound level and variation of bound level for short injections. Four parameters variation in a design reduced to 10 experiments with 6 replicates

Parameters were:

1. Sample aspiration flow rate.

2. Mixing flow rate.

3. Contact flow rate.

4. Sample volume.

5. Flowcells (extra parameter for free)

Responses were:

1. Bound level of antibody RelResp RU

2. Stdev of bound antibody RelResp RU

3. Relative stdev of bound antibody CV %

### Result of Immobilization of Protein A

Note: Deactivation was done in a separate run. Therefore the baseline absolute response from first run and absolute response from second run was used to calculate immobilized level. All flow cells were immobilized with protein A as shown in table 1.

TABLE 1
Immobilized level of protein A

| | | baseline | |
|---|---|---|---|
| Flowcell | basline | after | immob |
| no | before | immob | RU |
| 1 | 40442 | 35847 | 4595 |
| 2 | 40486 | 35827 | 4659 |
| 3 | 40142 | 35689 | 4453 |
| 4 | 39983 | 35582 | 4401 |
| 5 | 39906 | 35545 | 4361 |
| 6 | 39959 | 35615 | 4344 |
| 7 | 40222 | 35763 | 4459 |
| 8 | 40284 | 35870 | 4414 |

Short Injections. Run Order and Result.

Table 2 shows run order and results of factorial experiment. It is shown that contact flow and sample volume control the response level and that mix flow and aspiration flow has minor effect on response level and variation of response. It is also shown that contact time and sample volume are direct proportional to response level. The precision varied between 5% CV and 10% CV.

TABLE 2
Design and result of reduced factorial experiment.

| | | sample | | | | Antibody response | Antibody response | Antibody response |
|---|---|---|---|---|---|---|---|---|
| Run | | aspiration | Mix | Contact | Sample | average fc and | SD fc and | CV % fc and |
| Order | Incl/Excl | flow | flow | flow | volume | cycles | cycles | cycles |
| 1 | Incl | 15 | 105 | 150 | 3 | 896 | 93 | 10.4 |
| 2 | Incl | 60 | 70 | 150 | 2 | 648 | 56 | 8.7 |
| 3 | Incl | 15 | 35 | 50 | 3 | 1760 | 96 | 5.5 |
| 4 | Incl | 15 | 70 | 100 | 3 | 1137 | 74 | 6.5 |
| 5 | Incl | 30 | 105 | 50 | 2 | 1141 | 69 | 6.1 |
| 6 | Incl | 30 | 35 | 100 | 2 | 836 | 76 | 9.1 |
| 7 | Incl | 30 | 70 | 150 | 2 | 622 | 50 | 8.1 |
| 8 | Incl | 30 | 70 | 100 | 2 | 794 | 39 | 5.0 |
| 9 | Incl | 60 | 105 | 100 | 1 | 436 | 45 | 10.2 |
| 10 | Incl | 60 | 70 | 50 | 3 | 1713 | 104 | 6.1 |

n = 6

### 2.1.2.3. Ultra Short Injections

The limit for using small sample volumes was tested by doing injections of Biatest solution in a series of decreasing volumes from 1.5 μl to 0.25 μl and with 9 replicates for each volume. The flow parameters were 15, 35 and 50 μl/min for sample aspiration flow, mix flow and contact flow respectively. Average peek relative response, standard deviation and CV % was calculated. The peek response was found by opening the result file in BIACORE T100 evaluation software (GE Healthcare, Uppsala, Sweden).

Look for the max value in each response column. This relative peek response was assumed to be the least dilution factor and it was compared with undiluted Biatest solution having a relative response of 22 500 RU.

In Table 3 it is shown that 1.5 μl sample results in seven fold dilution with a relative standard deviation (CV %) of 5%. Sample volumes with less than 1.5 μl resulted in ca 10% CV. The variation of responses is larger between cycles than between flow cells. This is explained by the function of the peristaltic pump.

TABLE 3
Short injections of Biatest solution.

| fc | vol | Average | Stdev | CV % | n | Dilution factor |
|---|---|---|---|---|---|---|
| 1 | 0.25 | 480 | 61 | 12.8 | 9 | 42 |
| 2 | 0.25 | 480 | 62 | 13.0 | 9 | 42 |
| 3 | 0.25 | 549 | 64 | 11.6 | 9 | 36 |
| 4 | 0.25 | 552 | 66 | 12.0 | 9 | 36 |
| 5 | 0.25 | 549 | 58 | 10.5 | 9 | 36 |
| 6 | 0.25 | 521 | 68 | 13.0 | 9 | 38 |
| 7 | 0.25 | 483 | 51 | 10.6 | 9 | 41 |
| 8 | 0.25 | 479 | 64 | 13.4 | 9 | 42 |
| total | 0.25 | 512 | 67 | 13.2 | 72 | 39 |
| 1 | 0.5 | 1016 | 127 | 12.5 | 9 | 20 |
| 2 | 0.5 | 990 | 111 | 11.2 | 9 | 20 |
| 3 | 0.5 | 1098 | 121 | 11.0 | 9 | 18 |
| 4 | 0.5 | 1113 | 115 | 10.3 | 9 | 18 |
| 5 | 0.5 | 1062 | 101 | 9.5 | 9 | 19 |
| 6 | 0.5 | 1026 | 112 | 10.9 | 9 | 19 |
| 7 | 0.5 | 965 | 105 | 10.9 | 9 | 21 |
| 8 | 0.5 | 975 | 134 | 13.7 | 9 | 21 |
| total | 0.5 | 1031 | 122 | 11.8 | 72 | 19 |
| 1 | 1 | 1965 | 236 | 12.0 | 9 | 10 |
| 2 | 1 | 1935 | 202 | 10.4 | 9 | 10 |
| 3 | 1 | 2069 | 223 | 10.8 | 9 | 10 |
| 4 | 1 | 2073 | 257 | 12.4 | 9 | 10 |
| 5 | 1 | 1914 | 209 | 10.9 | 9 | 10 |
| 6 | 1 | 1891 | 192 | 10.2 | 9 | 11 |
| 7 | 1 | 1782 | 200 | 11.2 | 9 | 11 |
| 8 | 1 | 1834 | 192 | 10.4 | 9 | 11 |
| total | 1 | 1933 | 226 | 11.7 | 72 | 10 |
| 1 | 1.5 | 3047 | 138 | 4.5 | 9 | 6.6 |
| 2 | 1.5 | 2991 | 133 | 4.4 | 9 | 6.7 |
| 3 | 1.5 | 3171 | 158 | 5.0 | 9 | 6.3 |
| 4 | 1.5 | 3195 | 177 | 5.5 | 9 | 6.3 |
| 5 | 1.5 | 2875 | 144 | 5.0 | 9 | 7.0 |
| 6 | 1.5 | 2852 | 123 | 4.3 | 9 | 7.0 |
| 7 | 1.5 | 2689 | 135 | 5.0 | 9 | 7.4 |
| 8 | 1.5 | 2831 | 127 | 4.5 | 9 | 7.1 |
| total | 1.5 | 2956 | 214 | 7.2 | 72 | 6.8 |

Sample volume is presented in μl. Peak response and stdev is presented as RelResp(RU). The dilution factor is RelResp of Biatest solution (22500 RU) divided by RelResp of peak response.

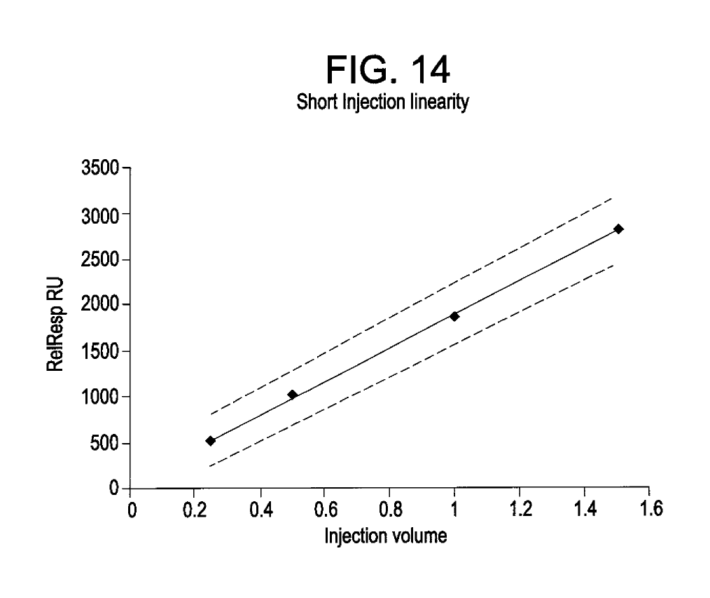

The dilution factor was linear down to 40 fold dilution (FIG. 14). Y-axis is the overall average response for all flow cells and cycles and the X-axis is the sample volume in μl presented in Table 3. The dotted lines represent the limits for the confidence interval of 99%.

### 2.1.3. Flow Rate Fluctuations

In order to understand the variation of the peek responses of short injection, a look at real flow rate fluctuations, caused by the peristaltic pump could give help. Pump fluctuations were tested.

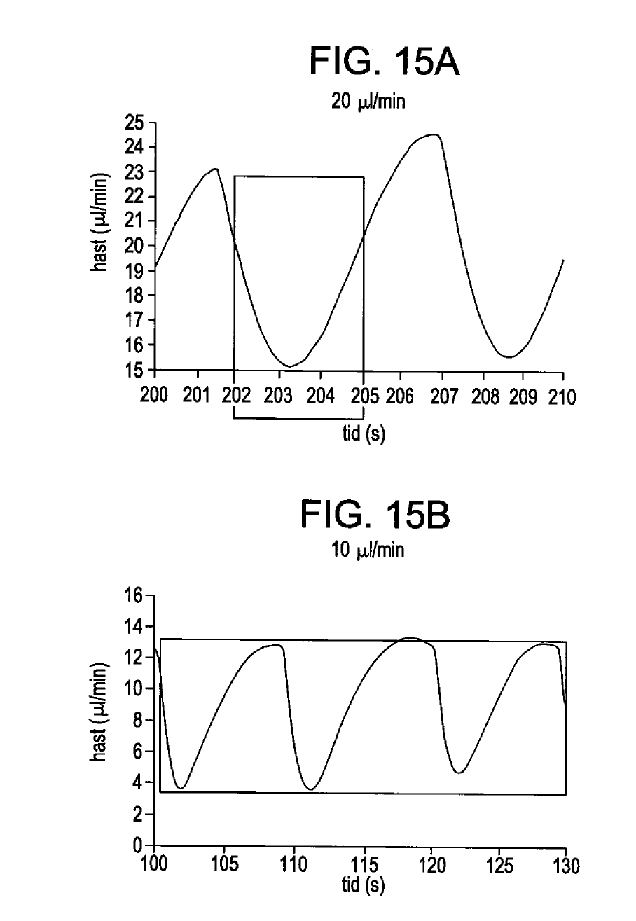

Flow rate was measured using a flow rate meter. Nominal flow rates of 10 and 20 μl/min were tested. The aspiration flow rate for short injection is 15 μl/min. In FIGS. 15 A and B it is shown that there is a flow rate variation of ±4.5 μl/min with a frequency of ca 1 μl between bottom to top flow rate for both 10 and 20 μl/min. The volume that will be aspirated is an integrated volume within the aspiration time. In worst case when aspirating 0.25 μl it could vary between 0.17 to 0.33 μl or ±30% which correlate well with the results shown in Table 3 if one choose three 3 times stdev=99% confidence interval. However for larger aspiration volumes the variation will decrease accordingly.

In summary, short injection may be used for simultaneously automated dilution and concentration analysis of a sample in Biacore Q100. The sample can be diluted up to 40 times in this set up. Although the variation is relatively high at dilutions more than 10 times, a more accurate pump would help mitigate this situation e.g. using a syringe pump or any more accurate pump.

### Example 4

### Proof of Concept—Combined Inline Mixing of 15% Sugar and Running Buffer

### Materials and Methods

### 1.1 Materials

| | | |
|---|---|---|
| Instrument | Modified eight parallel flow system of | Biacore |
| | Biacore Q100. Each flowchannel is | |
| | equipped with 2 flowcells in serial mode, | |
| | see FIGS. 1, 2 and 3. Here, one channel | |
| | out of eight is described. | |
| Pumps | Two Cavro ® XMP 6000 Multi-Channel | Tecan |
| | pumps equipped with eight channels each, | |
| | one for flow and one for dispensing and | |
| | flow. | |
| Samples | Biatest solution | Biacore |
| Running buffer | HBS EP+ | Biacore |
| Sensor chip | CM5 | Biacore |

### 1.2 Methods

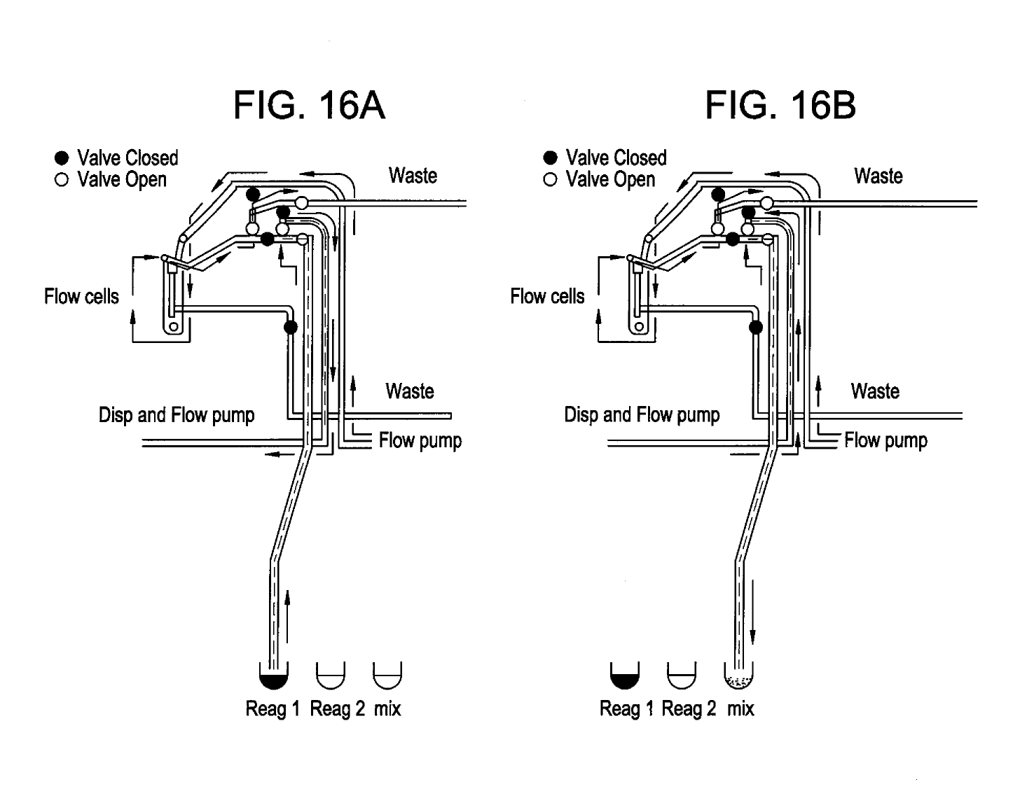

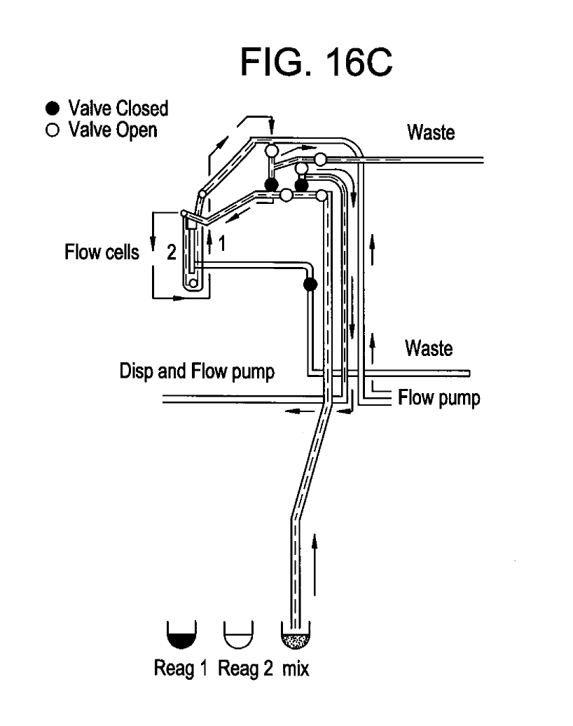

In this example 27 times 2 μl segments of reagent A and B respectively were aspirated at 120 μl/min resulting in a total mixture volume of 114 μl. Separation from running buffer was performed by introducing a 3 μl air segment as the first step. A portion of 92 μl was dispensed back into a separate mix well at forced flow of 1000 μl/min. The remaining 22 μl stays in the conduit. The mixing performance was tested by immediate injection of 25 μl mixed sample at 15 μl/min (Dispense pump operates at 30 μl/min and flow pump at 15 μl/min) (FIG. 16.)

### 2. Results

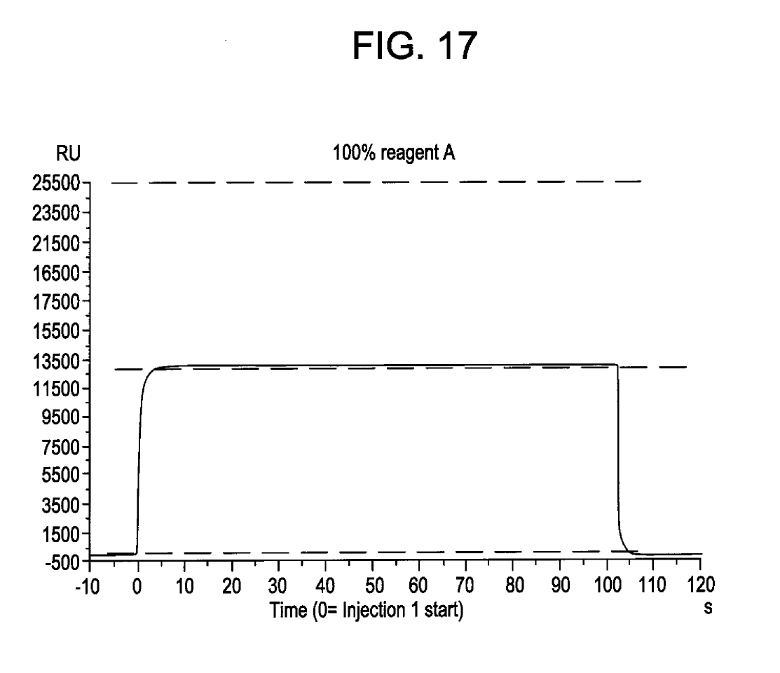

It is shown in Table Four that the precision of combined inline mixing is very good and that aimed mixing level is achieved. The result is also shown in FIG. 17. The sample mixed by this new combined inline mixing method is homogenously mixed.

TABLE 4
Combined inline mix of Biatest solution and running buffer. The
bulk response of injected mix solution and stdev is presented as
RelResp(RU). The dilution factor is RelResp of Biatest solution
divided by RelResp of mixed sample response.

| | | | | Diff from |
|---|---|---|---|---|
| | RelResp | RelResp | Mix factor | expected |
| Flowcell | Biatest | 50/50 mix | procent | procent |
| 1 | 24886 | 12900 | 51.8 | 3.7 |
| 10 | 25033 | 12962 | 51.8 | 3.6 |
| 13 | 22698 | 11663 | 51.4 | 2.8 |
| 14 | 22922 | 11811 | 51.5 | 3.1 |
| 15 | 24740 | 12825 | 51.8 | 3.7 |
| 16 | 24680 | 12819 | 51.9 | 3.9 |
| 2 | 24846 | 12849 | 51.7 | 3.4 |
| 5 | 24584 | 12721 | 51.7 | 3.5 |
| 6 | 24391 | 12595 | 51.6 | 3.3 |
| 7 | 24886 | 12847 | 51.6 | 3.2 |
| 8 | 24846 | 12815 | 51.6 | 3.2 |
| 9 | 24910 | 12726 | 51.1 | 2.2 |
| | | Average | 51.6 | 3.3 |
| | | Stdev | 0.2 | |
| | | CV % | 0.45 | |

All patents, patent publications, and other published references mentioned herein are hereby incorporated by reference in their entireties as if each had been individually and specifically incorporated by reference herein. While preferred illustrative embodiments of the present invention are described, one skilled in the art will appreciate that the present invention can be practiced by other than the described embodiments, which are presented for purposes of illustration only and not by way of limitation. The present invention is limited only by the claims that follow.

1. In a method of characterizing an interaction in a liquid environment, between at least one species in solution and a target immobilized on a surface of a flow cell, which method comprises the steps of:
(a) activating the surface of said flow cell and immobilizing said target thereon;
(b) providing, in a flow of liquid, at least one of the species;
(c) passing the flow of liquid comprising at least one of the species through said surface of the flow cell which contains the immobilized target; and
(d) detecting a result of an interaction between the at least one species and the target using surface plasmon resonance (SPR) technique;
the improvement comprising: in at least one of steps (a) or (b), inline mixing at least two liquid solutions to generate a mixed solution before it is passed through the surface of said flow cell.

2. The method of claim 1, wherein said inline mixing comprises the following steps:
(1) placing a multi-chambered flow cell in an integrated fluidic cartridge (IFC);
(2) connecting a multiplex needle and tube block with said integrated fluidic cartridge, wherein needles in said multiplex needle and tube block are spaced such that each needle could reach a separate reagent well in a standard multiwell plate such as a well in a 96-well plate, further wherein a conduit is formed among each of said needles and connected tube, a channel of said IFC and a flow cell chamber;
(3) aspirating into the needle a first liquid solution from the reagent container using a pumping means;
(4) without introducing an air bubble, aspirating a second liquid solution from a different reagent container; and
(5) optionally repeat steps (3) and (4); whereas mixing of the first and second liquid solution occurs before the mixed solution reaches the surface of said flow cell.

3. The method of claim 2, wherein the steps are controlled by a computer program, with the multiplex needle and tube block moving vertically, while a reagent block carrying said reagent containers move horizontally.

4. The method of claim 1, wherein said mixed solution contains at least one chemically unstable component.

5. The method of claim 1, wherein inline mixing is used in step (a), to mix EDC and NHS, for amine coupling of antibodies to the flow cell surface.

6. The method of claim 1, wherein inline mixing, during step (b), of an acidified antibody containing solution and a high pH solution neutralizes the antibody, before subjecting said antibody to a binding interaction with said target on the flow cell surface.

7. The method of claim 2, wherein said multiplex needle and tube block contains 8 or 12 needles that are spaced such that each needle could reach a separate well of a row of wells in a 96-well plate.

8. The method of claim 2, wherein said pumping means is a peristaltic pump or a syringe pump.

9. The method of claim 2, wherein each aspirating step takes in a solution of from about 0.1 to about 10 μl.

10. The method of claim 2, wherein each aspirating step takes in a solution of from about 0.25 to about 4 μl.

11. The method of claim 2, wherein each aspirating step takes in a solution of from about 0.5 to about 4 μl.

12. The method of claim 2, wherein the flow rate for the liquid through the flow cell is from about 10 to about 100 μl/min.

13. The method of claim 2, wherein the flow rate for the liquid through the flow cell is from about 10 to about 60 μl/min.

14. The method of claim 2, wherein the flow rate for the liquid through the flow cell is from about 10 to about 30 μl/min.

15. A method for the analysis of a highly concentrated sample species, comprising subjecting the sample to an SPR assay for characterizing an interaction between said species and a target immobilized on a surface of a flow cell, which method comprises the steps of:
(a) activating the surface of said flow cell and immobilizing said target thereon;
(b) providing, in a flow of liquid, said species of a suitable concentration;
(c) passing the flow of liquid comprising the species through said surface of the flow cell which contains the immobilized target; and
(d) detecting a result of an interaction between the species and the target using surface plasmon resonance (SPR) technique;
the improvement comprising: inline mixing, under the control of a computer, said highly concentrated sample species with a buffer to generate a mixed solution before step (b), the inline mixing comprises the following steps:
(1) placing a multi-chambered flow cell in an integrated fluidic cartridge (IFC);
(2) connecting a multiplex needle and tube block with said integrated fluidic cartridge, wherein needles in said multiplex needle and tube block are spaced such that each needle could reach a separate reagent well in a standard multiwell plate such as a well in a 96-well plate, further wherein a conduit is formed among each of said needles and connected tube, a channel of said IFC and a flow cell chamber;
(3) aspirating into the needle a buffer solution using a pumping means;
(4) without introducing an air bubble, aspirating a desired amount of the highly concentrated sample; and
(5) without introducing an air bubble, aspirating a second volume of said buffer solution;
wherein dilution of the highly concentrated sample occurs in said conduit, before the sample reaches the surface of said flow cell.

16. The method of claim 15, wherein the sample is diluted between 5-100 times.

17. The method of claim 15, wherein the sample is diluted between 10-40 times.

18. The method of claim 2, further comprising, after step (5), dispensing the liquid solutions from said conduit to a mixing container, and aspirate the sample back from said mixing container.
